(19) United States
(12) Patent Application Publication
(10) Pub. No.: US 2015/0088274 A1
(43) Pub. Date: Mar. 26, 2015

(54) METHOD FOR CONDITIONING A TOOL FOR CONFIGURING A FREELY PROGRAMMABLE CONTROL DEVICE

(71) Applicant: ABB TECHNOLOGY AG, Zurich (CH)

(72) Inventors: Dirk WAGENER, Stadthagen (DE); Christoph Welte, Neu-Ulm (DE); Marcus Heege, Kaisersesch (DE); Wolfgang Mahnke, Hettenleidelheim (DE); Marko Schlüter, Espelkamp (DE)

(73) Assignee: ABB TECHNOLOGY AG, Zurich (CH)

(21) Appl. No.: 14/495,290

(22) Filed: Sep. 24, 2014

(30) Foreign Application Priority Data
Sep. 24, 2013 (DE) DE 102013015923.7

(51) Int. Cl. G05B 19/05

(52) U.S. Cl. CPC G05B 19/05; G05B 2219/15025
USPC 700/19

(57) ABSTRACT

A method is disclosed for conditioning a tool for configuring a freely programmable control device for integrating intelligent field devices in a control or automation system having a flexibly expandable hardware structure, in which device-related information is visualized as objects of a branched tree structure. To improve user-friendliness, recording use of these objects by the user over the service life of the control or automation system allows for determining usage frequency. Objects with a high usage frequency which are subordinate to a hierarchically superordinate object are allocated to an object list assigned to the respective superordinate object. When using the hierarchically superordinate object, the object list containing the objects with a high usage frequency which are hierarchically subordinate to this superordinate object is displayed in the tool and offered to the user for selection.

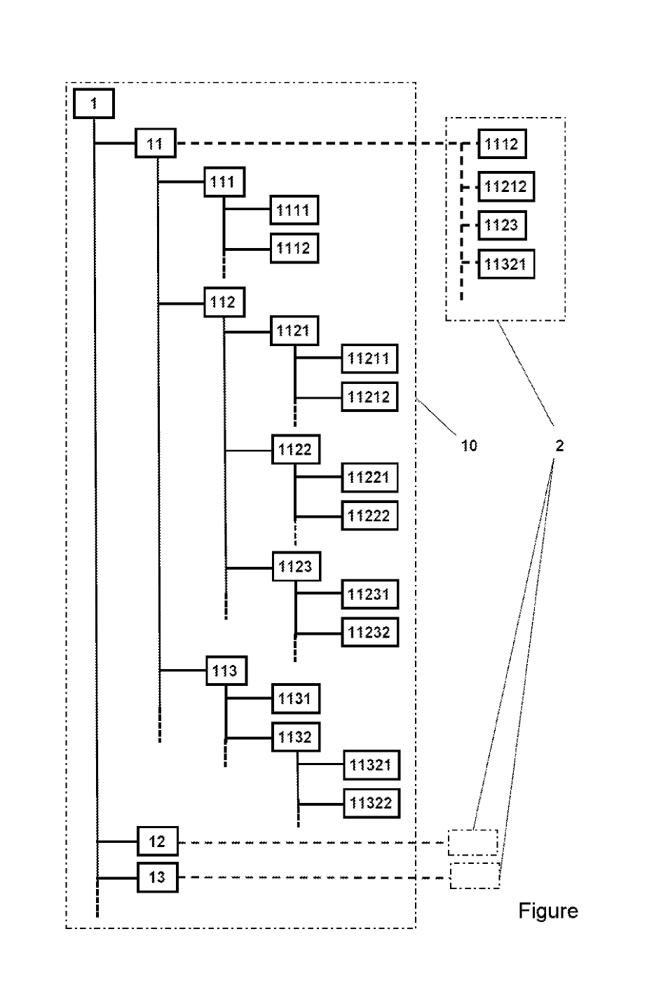

### RELATED APPLICATION

This application claims priority under 35 U.S.C. §119 to German Patent Application No. 102013015923.7 filed in Germany on Sep. 24, 2013, the entire content of which is hereby incorporated by reference in its entirety.

### FIELD

The present disclosure relates to a method for conditioning a tool for configuring a freely programmable control device for integrating intelligent field devices in a control or automation system having a flexibly expandable hardware structure. Embodiments can be used, for example, in process automation or machine control for controlling processes and/or installation components.

### BACKGROUND INFORMATION

Automation systems for controlling a technical process or a technical installation can include a control device (PLC) which is integrated in a group of a multiplicity of intelligent electrical devices, also called Intelligent Electronic Devices (IED). Intelligent electronic devices are microprocessor-based devices, for example protective and control devices, motor protective devices, intelligent switches and voltage regulators, frequency converters, pressure and temperature measuring transducers, flowmeters and actuators.

Communication between the control device and the intelligent electrical devices (IED) can be carried out using a communication protocol, such as using the IEC 61850 communication standard, and is described in

EP 1 976 281 A1, for example. In order to interchange data within the system, it is necessary to configure the devices (IEDs) using a programming tool or programming device, also called engineering tool, and to incorporate the devices in the communication network operating according to the IEC 61850 standard.

In order to interchange information between the devices, from which the control or automation system is formed, that is to say to interchange data between functions implemented in the devices, the communication nodes are first of all considered to be the smallest part of a function which interchanges data with other functions. These logical nodes carry out subfunctions for the overall function and can be implemented individually or together in devices.

Each device has a firmly defined number of parameters and functions which are equivalently presented to the user of the engineering tool. However, only a few parameters and functions are generally required. These vary according to the industry segment, process phase of the installation and type of use. For example, particular functions of a device are required only for start-up and only for maintenance, whereas other parameters and functions are relevant only during ongoing operation.

The parameters and functions are grouped and visualized in a multi-branched hierarchical arrangement in the tool. DE 101 17 459 A1 discloses a method and an apparatus for obtaining diagnostic information, which apparatus uses an engineering tool which visualizes the device-related information as objects of a multi-branched tree structure in a hierarchical arrangement. In this tree structure, the user has access to parameters and functions in order to adjust the device and perform diagnoses or other functions.

In order to read or change parameters and perform functions, the user must first of all find and select them using a menu structure having different input windows. Since field devices often have a large number of different menus and input windows with many parameters and functions, the user must often search for the parameters for his application in order to be able to identify and execute them. This search can be very time-consuming and confusing given the multiplicity of parameters and functions. It is also possible that the user does not perceive useful parameters and functions at all because they are concealed in the complex structure of menus and input fields. This has been perceived to be disadvantageous.

### SUMMARY

A method is disclosed for conditioning a tool for configuring a programmable control device for integrating intelligent field devices in a control or automation system having an expandable hardware structure, in which device-related information is hierarchically arranged and visualized as objects of a multi-branched tree structure, the method comprising: recording, during use of the tool, use of objects by a user over a service life of the control or automation system; determining the usage frequency of individual objects of the control or automation system from the historical usage data; allocating objects with a high usage frequency, which are subordinate to a hierarchically superordinate object, to an object list which is assigned to a respective superordinate object; and when using a given hierarchically superordinate object, displaying the object list containing the objects with a high usage frequency which are hierarchically subordinate to the given hierarchically superordinate object in the tool, for access by the user for selection.

### BRIEF DESCRIPTION OF THE DRAWINGS

Exemplary embodiments are explained in more detail below in conjunction with the drawing, wherein:

The single figure illustrates a multi-branched tree structure in which the objects of a control or automation system are arranged in different hierarchical levels in a tool for configuring a freely programmable control device for integrating intelligent field devices in the control or automation system.

### DETAILED DESCRIPTION

The present disclosure is directed to, among other features, increasing the user-friendliness of known engineering tools.

Exemplary embodiments include a tool for configuring a freely programmable control device for integrating intelligent field devices in a control or automation system having a flexibly expandable hardware structure, in which device-related information is hierarchically arranged and visualized as objects of a multi-branched tree structure.

According to exemplary embodiments, during use of the tool, the use of these objects by the user over the service life of the control or automation system can be recorded.

The usage frequency of the individual objects of the control or automation system can be determined from the historical usage data.

The objects with a high usage frequency which are subordinate to a hierarchically superordinate object can be allocated to an object list which is assigned to the respective superordinate object.

When using the hierarchically superordinate object, the object list containing the objects with a high usage frequency which are hierarchically subordinate to this superordinate object can be displayed in the tool and offered to the user for selection.

Hierarchically subordinate objects which are for example frequently used in the current lifecycle phase of the control or automation system can therefore be directly accessible by the user of the tool. This can allow for dispensing with all intermediate steps for selecting and activating objects which are hierarchically arranged in the object list between the superordinate object and the subordinate object in the multi-branched tree structure.

Operation of the tool can be consequently simplified. In addition, the complicated search both in the branches of the multi-branched tree structure and in a selected hierarchical level of the latter can be dispensed with for frequently used hierarchically subordinate objects.

During a start-up phase of the control or automation system, the hierarchically subordinate objects in the object list can be precisely those which are used frequently in this current lifecycle phase, whereas other hierarchically subordinate objects which are frequently used during ongoing operation can be allocated to the object list.

According to another feature of the present disclosure, the objects with a high usage frequency can be determined in a user-group-specific manner. In extensive control or automation systems, different user groups can use the tool to perform different tasks and use the objects with different frequency. The user groups of start-up personnel, operating personnel and maintenance personnel can therefore use the objects of the control or automation system with a different usage frequency.

Precisely those objects which are used most often in the performance of its task and which differ from the objects of other user groups according to their usage frequency can be individually determined for each user group.

According to another exemplary feature of the present disclosure, objects with a high usage frequency can be determined in a user-specific manner. In relatively large control or automation systems, the user groups work on different tasks in a specialized manner and in a manner based on the division of labor. The usage frequency of the individual objects of the control or automation system can therefore vary within the user group in a user-specific manner.

For example, precisely those objects which are used most often in the performance of a user's given task and which differ from the objects of other users according to their usage frequency can be advantageously individually determined for each user.

According to another exemplary feature of the present disclosure, objects with a high usage frequency can be determined in a workstation-specific manner. Relatively large control or automation systems can often have a plurality of workstations for operating the control or automation system during ongoing operation, in which case at least one workstation is specifically reserved for maintenance work. The usage frequency of objects of the control or automation system during ongoing operation differs from those when maintaining the system.

For example, precisely those objects which are used most often in the performance of the task at each workstation and which differ from the objects of other workstations according to their usage frequency can be advantageously individually determined for this workstation.

According to another exemplary feature of the present disclosure, historical data relating to existing objects of the same object type can be provided for a new object, which historical data represent the usage behavior and from which the usage frequency of the new object of the control or automation system is determined.

The single figure illustrates an exemplary multi-branched tree structure which is known per se and in which the objects 1 to 11322 of a control or automation system 1′ are arranged in different hierarchical levels in a tool for configuring a freely programmable control device 1 for integrating intelligent field devices 11 to 13 in the control or automation system 1′.

The objects 1 to 11322 have one-digit to five-digit object designators, the number of digits in the object designators indicating the hierarchical level. The highest hierarchical level therefore has one-digit object designators and the lowest hierarchical level has five-digit object designators. Depending on the scope of the control or automation system 1′, sixth and further hierarchical levels may be provided.

The first hierarchical level, the control level, of the control or automation system 1′ has at least one object 1 which is formed by a control device 1.

The field devices 11, 12, 13 etc. which form the objects 11, 12, 13 etc. of the second hierarchical level, the device level, of the control or automation system 1′ are connected to the control device 1.

The field devices 11, 12, 13 etc. have a multiplicity of properties which can be selected and activated as parameters 1111, 1112, 11211 to 11232, 1131 and 11321 and 11322 grouped in menus 111, 112, 113 and submenus 1121 to 1123 and 1132.

The parameters 1111, 1112, 11211 to 11232, 1131 and 11321 and 11322 are objects to which no further objects are hierarchically subordinate. The menus 111, 112, 113 are objects to which further objects are hierarchically subordinate, which further objects may be submenus 1121 to 1123 and 1132 or parameters 1111, 1112, 1131. The submenus 1121 to 1123 and 1132 are objects to which further objects are hierarchically subordinate, namely the parameters 11211 to 11322.

In this case, the menus 111, 112, 113 are arranged on the third hierarchical level and the submenus 1121 to 1123 and 1132 are arranged on the fourth hierarchical level. The parameters 1111, 1112, 11211 to 11232, 1131 and 11321 and 11322 are accommodated on different hierarchical levels depending on the number and relevance. The parameters 1111, 1112 and 1131 are therefore arranged on the fourth hierarchical level under the menu 111 and the parameters 11211 to 11322 are arranged on the fifth hierarchical level below the submenus 1121 to 1123 and 1132.

In order to arrive at the parameter 11321 in the known multi-branched tree structure of the control or automation system 1′, the field device 11 can be selected in a first step starting from the control device 1. The menu 113 can be selected in a second step and the submenu 1132 can be selected in a third step. The parameter 11321 is reached in the fourth step.

According to an exemplary embodiment, during use of the tool for configuring a freely programmable control device 1 for integrating intelligent field devices 11, 12, 13 etc. in a control or automation system 1′, the use of these objects 1 to 11322 by the user over the service life of the control or automation system 1′ is recorded.

The use of an object 1 to 11322 includes, for example but not exclusively, written parameters 1111, 1112, 11211 to 11232, 1131 and 11321 and 11322, open windows, dialogs, menus 111, 112, 113 or submenus 1121 to 1123 and 1132, open tab pages in windows, dialogs, menus 111, 112, 113 or submenus 1121 to 1123 and 1132 or called methods.

The usage frequency of the individual objects 1 to 11322 of the control or automation system 1′ can be determined from the historical usage data. In this exemplary case, it is assumed that the objects 1 to 11322 with the highest usage frequency are searched for with the greatest probability.

The objects 1112, 11212, 11321 and 1123 with a high usage frequency which are subordinate to a hierarchically superordinate object 11 are allocated to an object list 2 which is assigned to the respective superordinate object 11. The object list 2 can be integrated in the tool in the form of a menu or context menu.

When using the hierarchically superordinate object 11, the object list 2 containing the objects 1112, 11212, 11321 and 1123 with a high usage frequency which are hierarchically subordinate to this superordinate object 11 can be displayed in the tool and offered to the user for selection.

In order to arrive at the parameter 11321, the field device 11 should be selected in a first step starting from the control device 1. The parameter 11321 is already reached in the second step from the object list 2 assigned to the field device 11. The number of necessary steps can be halved in comparison with a search in known multi-branched tree structures.

In an exemplary tool for configuring a freely programmable control device 1 for integrating intelligent field devices 11 to 13 in the control or automation system 1′, the frequently used parameters 1112, 11212, 11321 and/or menus/submenus 1123 can be advantageously directly assigned to the respective field devices 11 to 13 and can be quickly and conveniently reached by the user.

In a further exemplary refinement disclosed herein, provision may be made to divide the object list 2 into different categories. Such categories are, for example but not exclusively, parameters 1111, 1112, 11211 to 11232, 1131 and 11321 and 11322 changed last or changed most or functions called last or called most.

In a further exemplary refinement of the disclosure, provision may be made for the objects 1112, 11212, 11321 and 1123 with a high usage frequency to be determined in a user-group-specific, user-specific or workstation-specific manner.

In a further exemplary refinement of the disclosure, provision may be made for historical data relating to existing objects 1 to 11322 of the same object type to be provided for a new object 1 to 11322, which historical data can represent the usage behavior and from which the usage frequency of the new object 1 to 11322 of the control or automation system 1′ can be determined. The historical data may be imported, for example but not exclusively, by automatic installation with the tool, by manual installation using a data storage medium or by manual or automatic installation via the Internet.

In this manner, data relating to the use of these objects 1 to 11322 can be already available during first use of the tool for configuring a freely programmable control device 1 for integrating intelligent field devices 11 to 13 in a control or automation system 1′ in order to determine the usage frequencies.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

### 1 to 11322 Object

1′ Control or automation system
2 Object list

1. A method for conditioning a tool for configuring a programmable control device for integrating intelligent field devices in a control or automation system having an expandable hardware structure, in which device-related information is hierarchically arranged and visualized as objects of a multi-branched tree structure, the method comprising:
recording, during use of the tool, use of objects by a user over a service life of the control or automation system;
determining the usage frequency of individual objects of the control or automation system from the historical usage data;
allocating objects with a high usage frequency, which are subordinate to a hierarchically superordinate object, to an object list which is assigned to a respective superordinate object; and
when using a given hierarchically superordinate object, displaying the object list containing the objects with a high usage frequency which are hierarchically subordinate to the given hierarchically superordinate object in the tool, for access by the user for selection.

2. The method as claimed in claim 1, comprising:
determining the objects with a high usage frequency in a user-group-specific manner.

3. The method as claimed in claim 1, comprising:
determining the objects with a high usage frequency in a user-specific manner.

4. The method as claimed in claim 1, comprising:
determining the objects with a high usage frequency in a workstation-specific manner.

5. The method as claimed in claim 1, wherein historical data relating to existing objects of a same object type are provided for a new object, the method comprising:
determining from the historical data which represents a usage behavior, a usage frequency of the new object of the control or automation system.

6. The method as claimed in claim 2, comprising:
determining at least some of the objects with a high usage frequency in a user-specific manner.

7. The method as claimed in claim 6, comprising:
determining at least some of the objects with a high usage frequency in a workstation-specific manner.

8. The method as claimed in claim 2, wherein historical data relating to existing objects of a same object type are provided for a new object, the method comprising:
determining from the historical data which represents a usage behavior, a usage frequency of the new object of the control or automation system.

9. The method as claimed in claim 3, wherein historical data relating to existing objects of a same object type are provided for a new object, the method comprising:
determining from the historical data which represents a usage behavior, a usage frequency of the new object of the control or automation system.

10. The method as claimed in claim 4, wherein historical data relating to existing objects of a same object type are provided for a new object, the method comprising:
determining from the historical data which represents a usage behavior, a usage frequency of the new object of the control or automation system.

11. The method as claimed in claim 7, wherein historical data relating to existing objects of a same object type are provided for a new object, the method comprising:
determining from the historical data which represents a usage behavior, a usage frequency of the new object of the control or automation system.
